(19) United States
(12) Patent Application Publication
(10) Pub. No.: US 2004/0140175 A1
(43) Pub. Date: Jul. 22, 2004

(54) Bank note validation and storage apparatus

(76) Inventor: Felix Guindulain Vidondo, Peralta (Navarra) (ES)

Correspondence Address: KLAUBER & JACKSON, 411 HACKENSACK AVENUE, HACKENSACK, NJ, 07601

(21) Appl. No.: 10/626,444

(22) Filed: Jul. 24, 2003

(30) Foreign Application Priority Data
Jul. 31, 2002 (ES) P200201807

(51) Int. Cl. G07F 7/04

(52) U.S. Cl. 194/206

(57) ABSTRACT

Apparatus for bank note validation and storage to be used mainly in automatic machines dispensing products as well as game and prize recreational machines, having the apparatus (1) a bank note validation head (2) and a storage element (3) for bank notes validated as valid. The head (2) is defined by the hinged joint with two bodies (4, 5) attached according to a “L” shaped surface, with the head (2) incorporating a number of devices for validating bank notes, whilst the element (3) for bank note storage has a provisional housing (34), defined as a prolongation of the head's channel (6) and a final storage compartment (37).

### OBJECT OF THE INVENTION

The following invention, as expressed in the title to this specification, refers to an apparatus for bank note validating and storage, being of the type of apparatus mainly embodied in machines dispensing products by introducing coins and bank notes, as well as in recreational game and prize awarding machines, such that the apparatus for validating and storing bank notes allows the automatic machine to operate by inserting bank notes. The apparatus comprises a bank note validation head and a storage element.

Thus, using the apparatus being submitted, the machine embodying same is allowed to operate by introducing coins and bank notes, with bank note insertion being more versatile.

### FIELD OF APPLICATION

The bank note validating and storage apparatus described in this specification is applicable for fitting and installing in any kind of automatic machine that works by introducing coins and/or bank notes, and is particularly applicable in automatic machines dispensing products and in recreational game and prize giving machines.

### BACKGROUND TO THE INVENTION

As is well known, automatic dispensing machines for different products such as cigarettes became popular some years ago. They were initially operated just by introducing coins but, as time passed, certain machines commenced embodying bank note validating apparatus allowing machines to be operated both with coins and bank notes, which had to be validated.

We can thus mention European Patent E87305961 in which a “method and apparatus for controlling the diffuse reflectivity of one part of a surface” is presented, with the method being particularly applicable to detecting bank notes on the floor. The surface is exposed to a ray from a radiation source. At least part of the diffuse radiation reflected by the surface is detected by a sensor located behind an opening, so that the latter defines a detection position located in such a way that the intensity of the diffusely reflected radiation that has been detected does not essentially vary within a range of distances between the opening and the surface. The value that the diffuse reflectivity of the surface represents is then determined from the intensities detected.

We may also quote European Patent E90850335 where a “false document detector” is presented, based on a bank note examination device fitted with a groove formed at the top by a table under which there is a UV lamp mounted displaced from the groove. Part of a bank note inserted in the groove will be irradiated with UV radiation and a counter is able to ascertain the validity of a bank note by checking the fluorescent security printing in the latter.

Likewise, we may mention European Patent E91902655 in which a “bank note testing apparatus” is presented, which is an apparatus for testing bank notes or other similar payment items on sheets for automatic vending machines consisting in a checking channel with a carrying device and scanning device for recognising and checking the authenticity of bank notes facing which there is a variable width entry channel. The entry channel consists of two channels half separated on their longitudinal mid line which can be adjusted in synchronised fashion against the force of a spring. At their contact position, the channel halves determine the minimum of the channel's amplitude and in their extreme separation channel, the maximum amplitude or width. Any kind of bank note is introduced into the entry channel at the maximum width position far from the detector passage arranged in the beginning region or area of the checking channel. The detector passage unlocks the channel halves, as a result of which the side walls of the channel halves are under pressure by means of the force of a spring against the bank note and aligns it in a centred fashion with the checking channel.

Finally, we can mention European Patent E90912412 in which a method and the means for checking the authenticity of paper money is presented. They are based on the detection of the characteristic differences in the printing process for genuine bank notes and counterfeit bank notes produced by a colour photocopier. The detection is made in narrow wave length bands respectively in the red and blue colour bands and, simultaneously, in particular directions with the light reflected and scattered. For reference purposes, detection is also made in the intensity of a pertinent narrow band close to the eye's maximum sensitivity band, for example, in the green band. Measurement is preferably made at a particularly selected point where the blue and red contents in the printed copy of the genuine bank note is at one end, for example high or low.

### DESCRIPTION OF THE INVENTION

This specification describes an apparatus for bank note validating and storage, being of the type of apparatus mainly embodied in automatic product dispensing machines operated by inserting coins and notes, as well as in recreational game and prize giving machines, so that the apparatus comprises a head for note validation and an element which can be attached below it for storing bank notes validated as valid, with the head for note validating being defined by the hinged joining of two bodies, attached according to a “L” shaped surface with a rounded vertex, shaping a channel along which notes move for validation, with the note validating head incorporating the pertinent note entry detection means, means for controlling the rotation and speed of an operating motor with driving wheels for dragging the notes along, means for controlling the notes' movement between the pair of hinged bodies shaping the channel for passing through the head for validating the notes, means for obtaining the data of the notes to be validated for their comparison with the standard data stored and non-return security means for notes validated as valid, with the elements for storing notes validated as valid presenting a vertical entry housing, means for their movement to a final storage compartment and means for controlling coupling of the storage element to the head and filling thereof.

Thus, the means for detecting the pertinent notes's entry into the validation head are defined by an optical sensor that sends an order for activating an operating motor with driving wheels for moving the notes to the validation area, as well as the activation of a timer for undertaking such manoeuvre, so that the notes may be moved in both directions with the purpose of accepting them as valid or rejecting them to the insertion mouth.

Moreover, the timer is used to control the operation being performed in a pre-set time and, otherwise, it is returned.

The note validation head is defined by the hinged joint of two bodies, attached as per a “L” shaped surface with a rounded vertex, defining a thin channel, showing a fixed body to which the item defining the insertion mouth for the notes to be validated and a body hinged thereto is coupled.

The means for controlling the rotation and speed of the operating motor with driving wheels for pulling the notes, housed in the fixed body shaping the validation head, are defined by a disk, associated to its rotating shaft, and provided with grooves radial to its perimeter, in relation to which it displays an optic sensor controlling its rotation and its speed.

The means for controlling the bank note movement along the channel defined between the pair of hinged bodies shaping the note validation head, are defined by a wheel axially provided with a number of hollows in relation to which it presents an optic sensor, being housed in the fixed body shaping the head, whose wheel is in direct contact with the pertinent note to be validated, in order to know its speed of movement and that this is related to the speed of rotation of the motor operating the note pulling wheels.

Thus the note movement speed is controlled so as to be similar to the motor's rotation speed, given that if not, there is a jam and the note is expelled until the presence sensor no longer detects its presence or as a pre-set time passes, then waiting on stand-by for the note to be withdrawn by the user through the head's insertion mouth.

Moreover, the means for obtaining data of the notes to be validated for comparison with the standard data stored, in order to validate the notes as valid or false, are defined by a set of sensors which incorporate at least one optic reflexive measurement sensor, at least one optic sensor measuring through the notes and which may incorporate a magnetic head, controlling the note's position, as well as its correct advance.

The information read is thus linked to the exact position of the bank note.

The non-return security means for notes validated as valid are defined by a general “U” shaped body rotating round its core linked to the hinged body shaping the validation head, whilst its wings may be housed, by being interposed in the note movement channel, in respective recesses or mortises of the fixed note validation head shaping body.

Thus, once the note has been validated as valid, it is moved to the housing of the storage item, with the body in a general “U” shape basculating, being interposed in the passing channel and preventing a possible note extraction, i.e., acting as a non-return security mechanism should the note be tied to a thread and endeavour is made to withdraw it.

Moreover, at least one of the recesses or mortises made in the fixed note validation shaping body, in which the non-return security “U” shaped body's wings are housed, displays an optic sensor in order to notify the payment received.

Thus, when at least one wing of the general “U” shaped body is interposed between a sensor, the control system is notified that the note has been accepted and that payment has been received, after which the product is extracted.

The storage item which can be coupled below to the note validation head, displays a pair of wheels which, in their coupling to the head, are in contact with the pertinent head note pulling driving wheels, defining a vertical thin housing, as an extension of the note moving channel through the head, between a pair of fixed side members and a body intermediate to them movable for transferring notes to the final storage compartment, whilst this body is operated by a motor through levers.

In addition, the final storage compartment for the notes has a moving wall, guided at the bottom, on which the notes are stored, and this moving wall is pressurised by at least one spring making the notes stored stop against the pair of fixed side members which, in relation to their other side, define the entry housing of the notes validated as good and all notes stored are perfectly housed in a vertical position.

Likewise, the note validation and storage apparatus has means for controlling the coupling of the storage element to the head, which are defined by a micro.

In order to supplement the description to be made hereafter, and with the purpose of aiding in providing better understanding of the invention's characteristics, this specification is accompanied by a set of drawings in whose figures the invention's most characteristic details are given in an illustrative and non limiting fashion.

### BRIEF DESCRIPTION OF THE DRAWINGS

FIG. 1 shows a front view of the note validation head where the note insertion control cross groove can be seen.

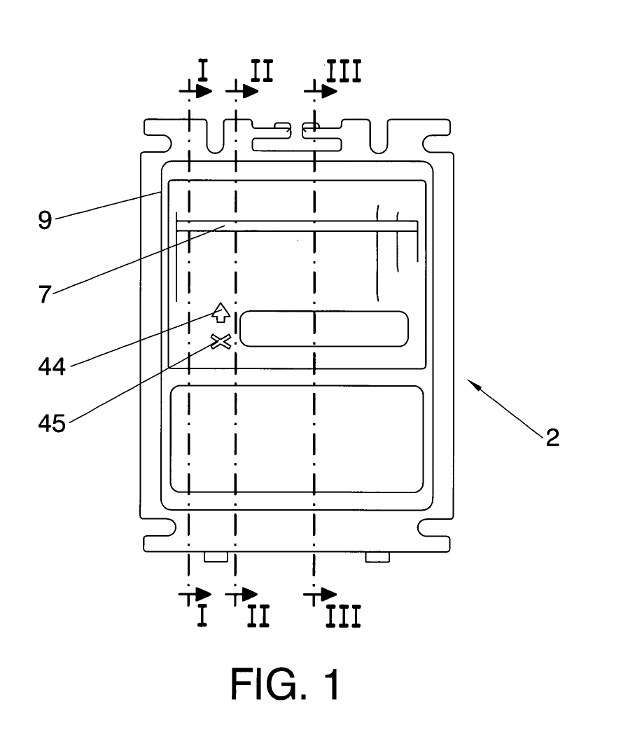

FIG. 2 shows a sectioned view of the note validation head through cut I-I of the foregoing figure, where the path taken by the notes for validation, as well as the grooved disc for detecting the note pulling wheel operating motor's rotation and speed can be observed.

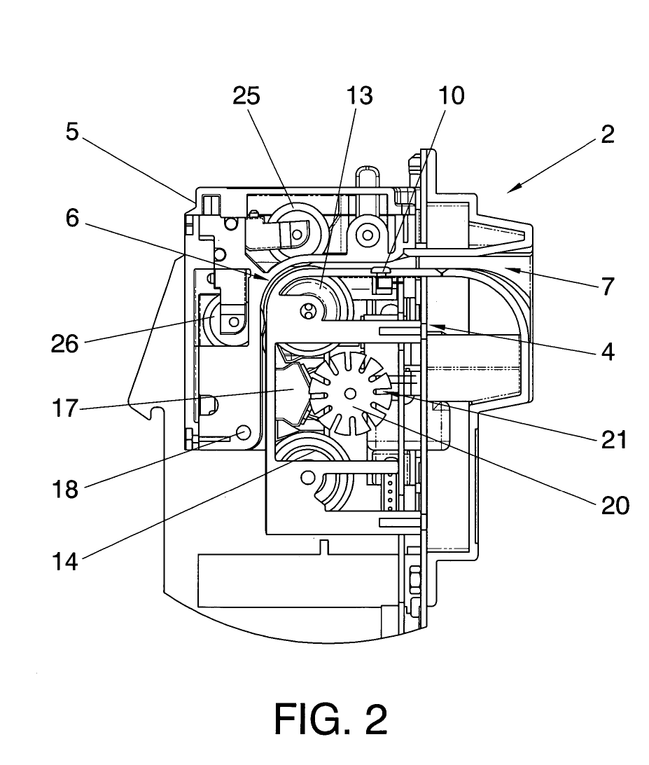

FIG. 3 shows a sectioned view of the note validation head through cut II-II of FIG. 1, where the path run by the notes for validation, as well as the non-return means defined by a “U” shaped body and a recess or mortise for housing their wings in relation to which, an optical sensor has been fitted.

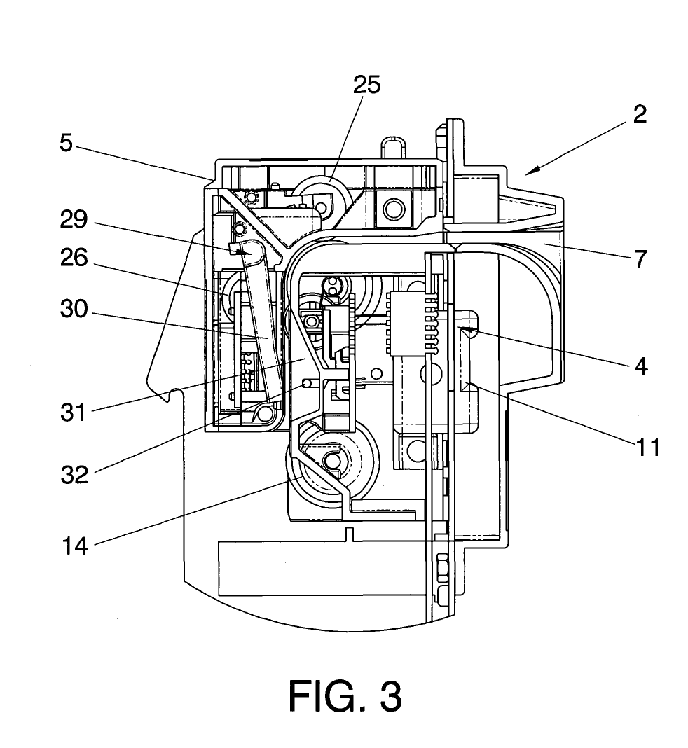

FIG. 4 shows a sectioned view of the note validation head through cut I-I of FIG. 1, where the path run by the notes for validation can be seen, as well as the wheel provided with axial hollows which is in continuous contact with the note allowing its advance to be controlled.

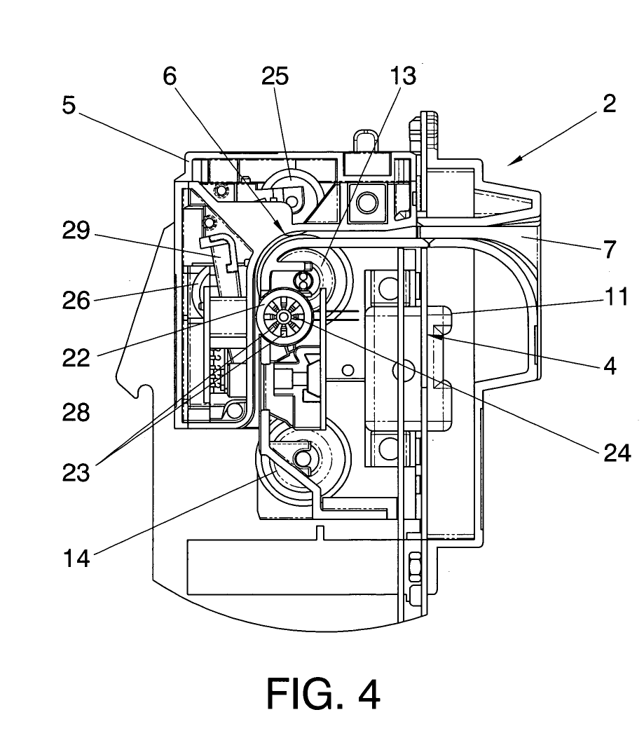

FIG. 5 shows a front view of the validation sensors, where the different sensors shaping the measurement making assembly can be seen.

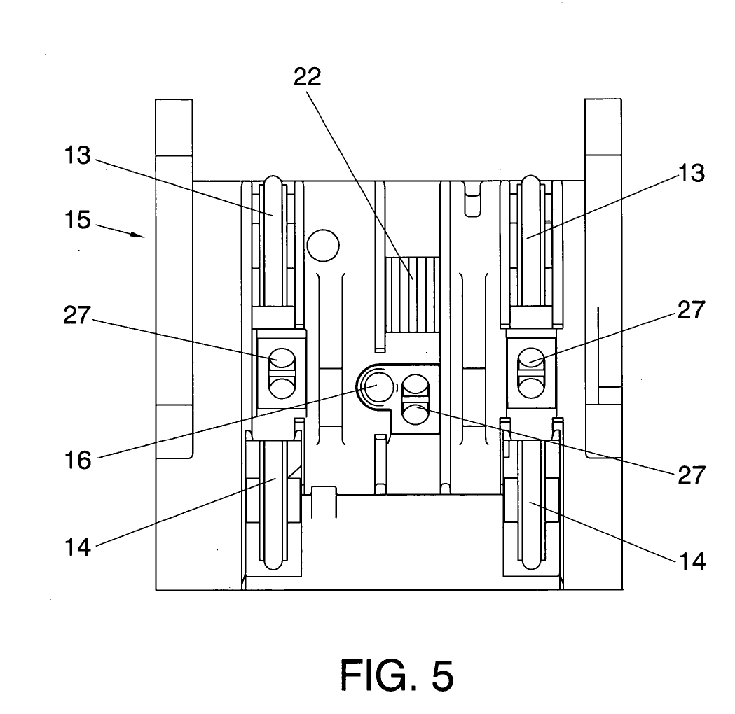

FIG. 6 shows a perspective of the note validation head where the open hinged body and the exploded view of the fixed body can be seen, together with the motor, the note pulling wheels, the sensor assembly and the frontispiece.

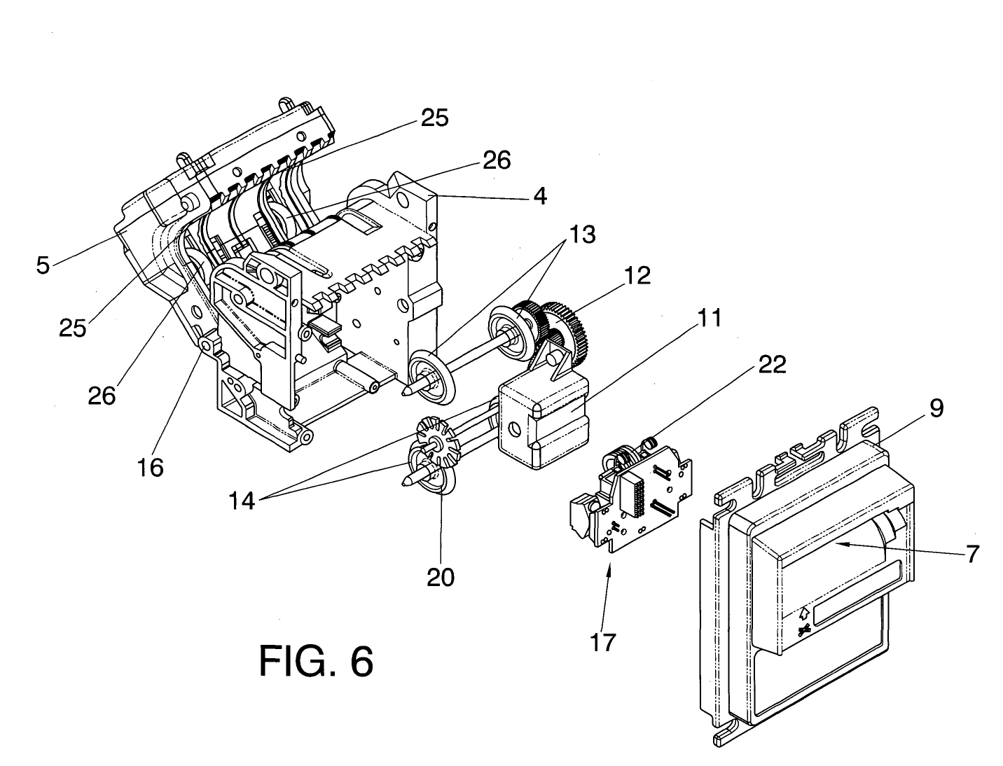

FIG. 7 shows a perspective of the note validation head, where the driving note pulling wheels and different components relating to the hinged body, in an exploded view, can be seen, as well as the “U” shaped body defining the non return mechanism.

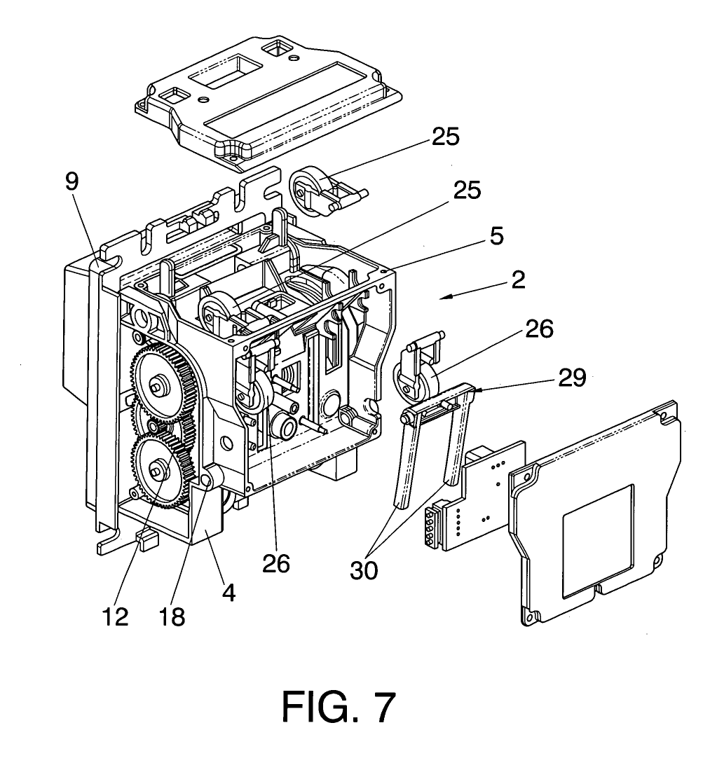

FIG. 8 shows an exploded view of the note storing element where its different components can be seen.

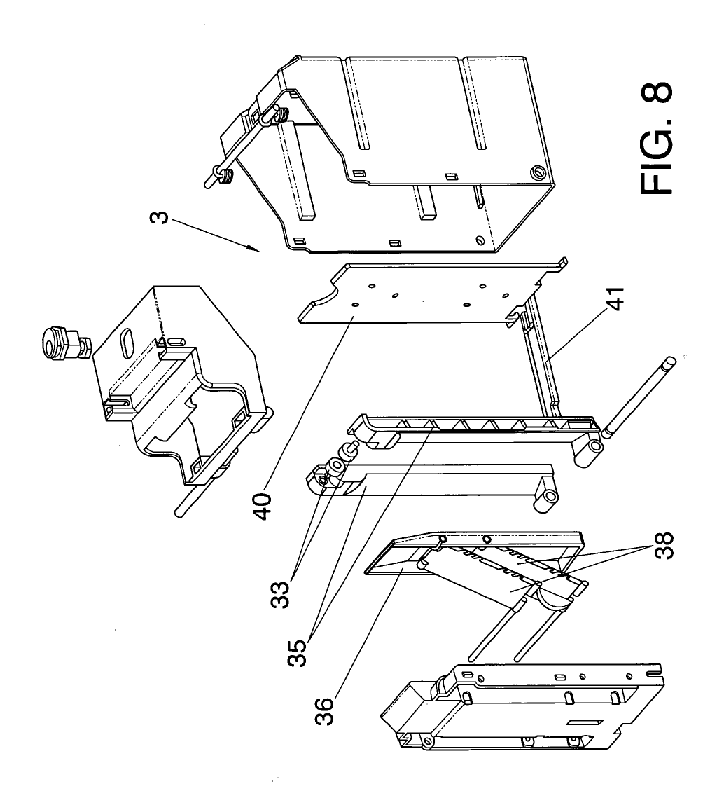

FIG. 9 shows a sectioned, side elevation of the note storage element, where different components thereof can be seen, such as the bottom guided moving wall, pressurised by a pair of springs, and the body in a continuous and broken line, that moves the notes to the final storage, and flat strips can be seen, represented by a broken line, through which the movement occurs.

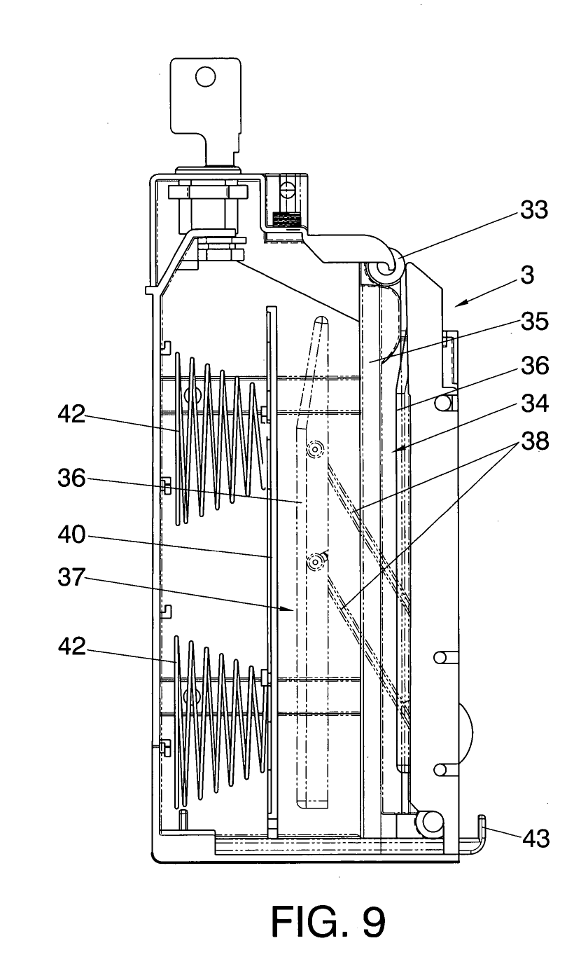

FIG. 10 shows a sectioned view in side elevation of the note validation apparatus, where it can be seen how the storage element is coupled at the bottom to the head and the note entry housing is as a continuation of the note passing channel through the head.

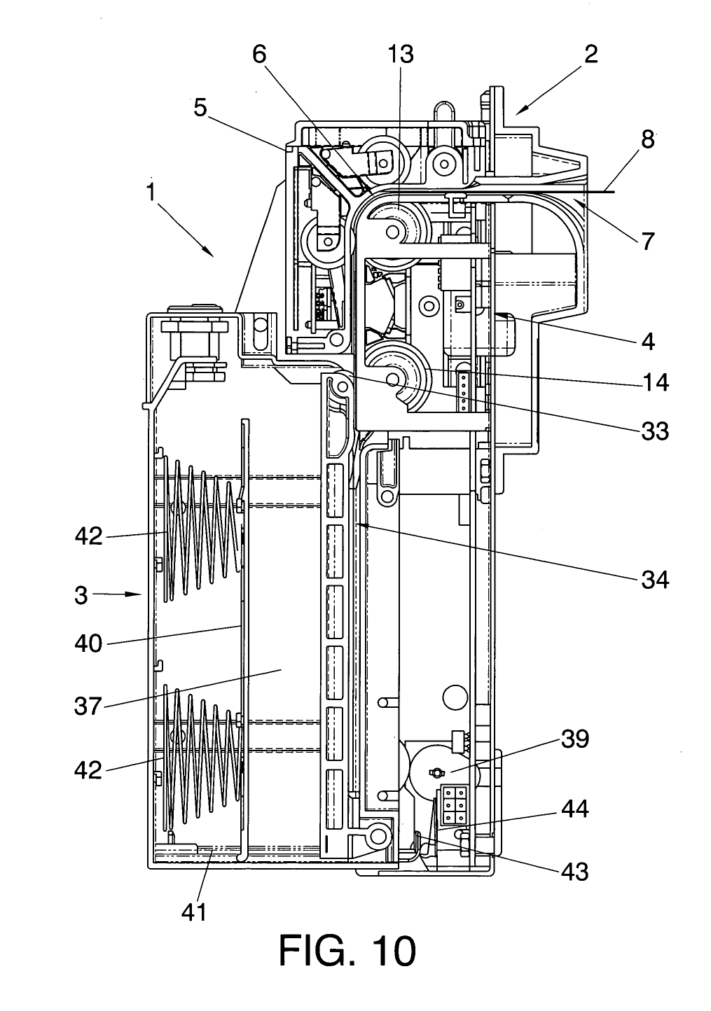

### DESCRIPTION OF A PREFERENTIAL EMBODIMENT

In the light of the aforementioned figures and in accordance with the numbering adopted, we can see how the note validation and storage apparatus 1 comprises a head 2 for the actual validation of the notes itself and an element 3, which can be coupled thereto at the bottom, for storing notes validated as valid, so that the note validation head is defined by the hinged joining of two bodies 4 and 5 attached as per a “L” shaped surface with a rounded vertex, shaping a channel 6 between the said surface wherealong the notes are moved for validation, with body 5 being hinged with respect to the fixed body 4 by a pin 18.

Likewise, body 4 shaping head 2 displays at the front a frame 9 fitted into the pertinent window of the machine's chassis and this frame 9 protrudes outwards so that the mouth 7 for inserting the notes 8 to be validated is defined at this front, which notes may be inserted in any position.

Moreover, the note validation head 2 embodies means for detecting the entry of the pertinent notes 8 through the insertion mouth 7 to the channel 6, which are defined by an optic sensor 10 that sends an order to activate an operating motor 11 so that, through the pertinent gear train 12, it transmits movement to note pulling driving wheels, being defined by two pairs of wheels 13 and 14 respectively mounted on respective rotation shafts, with respect to the fixed body 4 of the head 2, as well as to activate a timer to carry out the said validation manoeuvre.

Pairs 25 and 26 of free rotation wheels co-operate for correctly guiding the notes 8 along the movement channel 6, with the pair of driving wheels 13. They are mounted in relation to the hinged body 5 of the head 2 and are in contact with the pair of driving wheels 13, in an orthogonal position thereto, with respect to the rounded vertex which defines the note moving channel 6.

Thus, once the optic sensor 10 detects the presence of a note 8 and the motor 11 is activated with the purpose of moving the note to the area 15 relative to the position of a set 17 of measuring sensors, the arrival time is controlled, controlling its presence in the said sensor area 15 by means of an optic sensor 16, so that if the note 8 takes more than the pre-set time to reach the said area 15, it is returned. This optic sensor 16 also measures the notes to be validated and controls their departure from the said sensor area 15.

Likewise, the note validation apparatus embodies means for controlling the rotation and speed of the motor 11 driving the two pairs 13 and 14 of driving wheels for pulling the notes 8, with these means of control being housed in the fixed body 4 shaping the validation head 2, and which are defined by a disk 20 associated to the rotation shaft of the motor 11 and provided with grooves radial to its perimeter, in relation to which it displays an optic sensor 21 whereby its rotation and the speed thereof are controlled.

Moreover, the apparatus embodies means for controlling the movement of the notes 8 between the pair of hinged bodies 4 and 5 shaping the channel 6 passing through the note validation head 2. These means are defined by a wheel 22 axially provided with a series of hollows 23 in relation with which it displays an optical sensor 24, being housed in the fixed body 4 shaping the head 2, whose wheel 22 acts as a note jamming detector in the channel 6 for which it is in direct contact with the pertinent note 8 to be validated, in order to know its speed of movement and that it coincides with the rotation speed of the motor 11 operating the note pulling wheels.

Thus, if the speed of advance of the pertinent note, as detected by the wheel 22 with the optic sensor 24 is not related to the rotation speed of the motor 11, this is a sign of a jam, and, therefore, the note is expelled to the insertion mouth 7 to be picked up, on reversing the direction of rotation of the shaft of the motor 11.

The note validation apparatus 1 comprises means for obtaining data of the note 8 to be validated for comparison with the standard data stored, in order to validate the notes as valid or false, they are defined by a set 17 of sensors, with the purpose of making measurements of different types, for which they embody at least one reflexive optic measuring sensor 27, at least one optic sensor 16 for measuring through the notes and at least one magnetic head 28, whose contact wheel controls the note's position, as well as its correct advance.

Thus the set 17 of sensors embodies three optic sensors 27 through which optic reflexive measurements are made by the emission of a light in one or more wave lengths, which is reflected by the note, and, for this, a light emitter and receiver are placed on the same side of the note. We will obtain information on the colour and inks used in the note with this type of sensor.

Moreover, by means of the sensor 16, which detects the arrival and departure of the notes from the sensor area, optical measurements are made through the note by emitting light of different wave lengths, placing one emitter on one side of the note and a receiver on the other. We will obtain information on the inks and type of paper with which it is made with this kind of sensor.

Likewise, by means of the magnetic head 28, with which it is in direct contact with the note, by means of the wheel 22 which impels it against it, we obtain magnetic measurements providing us with information on the presence of magnetic security measures or not, both in the ink and in the paper of the note.

Whilst these measurements are being taken, it controls the note's position at all times, with the purpose of linking the information read to the exact position in which the note is found. In addition, during this whole process, check is made to see whether there are problems in the note's advance by means of the wheel 22 which is in direct contact with the latter and which is independent of the disk 20 controlling the speed of the motor 11.

Likewise, the apparatus 1 embodies non return security means for notes validated as valid, which are defined by a body 29 in a general “U” shape rotating around its core linked to the hinged body 5 shaping the note validation head 2 whilst its wings 30 can lodge in respective recesses 31 of the fixed body 4 shaping the note validation head 2, by being interposed in the note movement channel 6.

Moreover, at least one of the recesses 31 made in the fixed body 4 shaping the note validation head 2, in which the wings 30 of the non return, “U” shaped security body 29 displays an optical sensor 32 in order to detect the rotation of the said body 30 on having remained free through the note's movement so that if the note moves to the final storage element 3, through having been validated as valid, it cannot be withdrawn fraudulently and, in addition, it notifies payment made and the product ordered is collected.

Thus, we may state that once the measurements of the pertinent note to be validated have been taken, the note moves from the area of the set of sensors and this departure is detected by the sensor 16 and the note pulling pairs operating motor 11 stops just before passing the non return means, when the data taken are processed and analysed with the aim of correcting deviations caused by the tolerances when inserting the note or through wear of the mechanisms or of the note, and these data are compared with each of the pieces of data relating to the notes to be accepted stored in the memory of the electronic control system and it is determined whether the note is valid and whether it corresponds to any of the standards stored.

Thus, if the note is accepted as valid, motor 11 is activated making the note advance passing by the non-return device, preventing it from being fraudulently picked up, otherwise the note is rejected and moved to the insertion mouth 7.

The storage element 3 which is coupled at the bottom to the note validation head 2, displays a pair of wheels 33 which, in coupling to the head 2, remain in contact with the pair of note pulling driving wheels 14, defining a thin vertical housing 34, as an extension to the channel 6 moving the notes 8 through the head 2, materialised between a pair of fixed side members 35 and a body 36 intermediate to them which can move for transferring the notes from the housing 34 to the final storage compartment 37, with this body 36 activated by a motor 39, through flat strips 38.

Thus, when the motor 39 is activated, it moves the flat strips 38 moving the body 36 which moves the note housed in the housing 34 to the final compartment 37, attaching the note to the remaining notes located therein, for which the notes are stored on a moving wall 40 guided by a bottom guide 41 and pressurised by springs 42.

Thus the notes are stored consecutively in compartment 37 and the springs 42 make the notes stop against the pair of side members 35 until the compartment 37 is full.

The apparatus 1 displays a micro 44 on which a protrusion 43 of the final storage element 3 contacts in order for the control system to detect that it is coupled to the head 2.

Likewise, the micro 44 detects and notifies when the compartment is full.

The front of the apparatus 1, in relation to the element defining the note insertion mouth, displays a sign 44 to indicate that the apparatus is prepared to accept notes and a sign 45 to indicate that it is not ready to accept notes at that moment.

1. Apparatus for validating and storing bank notes, being of the type of apparatus mainly incorporated into automatic product vending machines by means of inserting coins and bank notes, as well as into game and prize recreational machines, wherein the apparatus comprises a note validation head and an element to be coupled below the note validation head, for storing notes validated as valid, the note validation head being defined by a hinged joining of two bodies, the bodies being attached according to an “L” shaped surface with a rounded vertex, shaping a channel along which the notes are moved for validation, the note validation head having means for detecting entrance of notes, means for controlling rotation and speed of a motor operating note pulling driving wheels, means for controlling movement of notes between the hinged bodies shaping the channel passing through the note validation head, means for obtaining the data of notes to be validated for comparison with the stored standard data and non-return security means for notes validated as valid, the element for storing notes validated as valid having a vertical entry housing, means for moving the notes to a final storage compartment and means for controlling coupling of the storage element to the head and filling of the storage element.

2. Apparatus for validating and storing bank notes according to claim 1, wherein the means for detecting entrance of the notes into the validation head comprise an optical sensor for sending an order to activate the motor operating pairs of wheels for moving the notes along the passing channel, and for activating a timer for performing the said manoeuvre.

3. Apparatus for validating and storing bank notes, according to claim 1, wherein the note validation head comprising the hinged joining of two bodies, attached according to an “L” shaped surface with a rounded vertex has a fixed body for coupling an element having a mouth for inserting notes to be validated.

4. Apparatus for validating and storing bank notes, according to any of claims 1 and 3, wherein the means for controlling rotation and speed of the motor operating the driving wheels for pulling the notes along, are housed in the fixed body shaping the validation head and comprise a disk associated to its rotation shaft and provided with grooves radial to its perimeter, in relation to which it has an optical sensor controlling its rotation and speed thereof.

5. Apparatus for validating and storing bank notes, according to any of claims 1 and 3, wherein the means for controlling the movement of the notes along the channel defined between the pair of hinged bodies shaping the note validation head comprise a wheel axially provided with a series of recesses in relation to which it has an optical sensor, being housed in the fixed body shaping the head, whose wheel is in direct contact with the pertinent note to be validated, to know its speed of movement and that it is related to the rotation speed of the motor operating the note pulling wheels.

6. Apparatus for validating and storing bank notes, according to claim 1, wherein the means for obtaining data of the notes to be validated for comparison with the stored standard data to validate notes as valid or false comprise a plurality of sensors which include at least one optical reflexive measurement sensor, at least one optical sensor for measuring through the notes, and optionally a magnetic head to control position and correct advance of a note.

7. Apparatus for validating and storing bank notes, according to claim 1, wherein the non return security means for notes validated as valid comprise a substantially “U” shaped body having a core and wings, said “U” shaped body rotating round the core and being linked to the hinged body shaping the validation head; the wings being permitted to be housed, by being interposed in the channel along which the notes are moved, in respective recesses of the fixed body shaping the note validation head.

8. Apparatus for validating and storing bank notes, according to claim 7, wherein at least one of the recesses made in the fixed body shaping the note validation head, in which the wings of the non-return security “•U” shaped body are housed has an optical sensor to prevent fraudulent withdrawal and to notify the payment received.

9. Apparatus for validating and storing bank notes, according to claim 1, wherein the storage element, to be coupled below the note validation head has a pair of wheels which in coupling to the head remain in contact with corresponding driving wheels pulling the notes through the head, defining, as a prolongation of the channel along which the notes are moved through the head, a thin vertical housing between a pair of fixed side members and a body intermediate to said fixed side members enabled to be moved so as to transfer the notes to the final storage compartment, said body being operated by means of a plurality of levers driven by a motor.

10. Apparatus for validating and storing bank notes, according to claim 9, wherein the final bank note storage compartment has a moving wall on which notes are stored, said moving wall being guided at the bottom and being under stress by at least one spring so as to make the stored notes stop against the pair of fixed side members, said fixed side members defining on their other side the entry housing for notes validated as good.

11. Apparatus for validating and storing bank notes, according to claim 1, wherein the means for controlling coupling of the storage element to the validation head, and for controlling the note storage compartment filling, comprise a microprocessor.
